(19) United States
(12) Patent Application Publication
(10) Pub. No.: US 2008/0065371 A1
(43) Pub. Date: Mar. 13, 2008

(54) Conversation System and Conversation Software

(75) Inventors: Mikio Nakano, Wako-shi (JP); Hiroshi Okuno, Kyoto-shi (JP); Kazunori Komatani, Kyoto-shi (JP)

Correspondence Address: RANKIN, HILL, PORTER & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/577,566

(22) PCT Filed: Feb. 27, 2006
(86) PCT No.: PCT/JP06/03613

§ 371 Date: Apr. 19, 2007

Related U.S. Application Data
(60) Provisional application No. 60/657,219, filed on Feb. 28, 2005.

(51) Int. Cl. G06F 17/27

(52) U.S. Cl. 704/9

(57) ABSTRACT

A system or the like is provided that is capable of interacting with a user while appropriately eliminating an inconsistency between a user's speech and a recognized speech.

According to the interactive system 100 of the present invention, an ith-order query Q₁ for asking a user's meaning is generated based on an ith-order output linguistic unit yₖᵢ related to an ith-order input linguistic unit xᵢ (i=1, 2, --) included in the recognized speech. Thereby, it is determined whether there is an inconsistency between the user's meaning and the ith-order input linguistic unit xi on the basis of an ith-order response Aᵢ recognized as a user's response to the ith-order query Qᵢ.

### TECHNICAL FIELD

The present invention relates to a system for recognizing a user's speech and outputting a speech to the user and software for providing a computer with functions necessary for the interaction with the user.

### BACKGROUND ART

At the time of interaction between a user and a system, an ambient noise or other various causes could lead to an error by the system in recognizing a user's speech (mishearing). Accordingly, there has already been suggested a technology for outputting a speech to confirm the content of user's speech in a system (refer to, for example, Japanese Patent Laid-Open No. 2002-351492). According to the system, if “attributes,” “attribute values,” and “distances between the attribute values” are defined for words and there are recognized a plurality of words whose attribute values are different from each other in spite of having a common attribute and whose differences between the attribute values (the distances between the attribute values) are each equal to or greater than a threshold value during an interaction with the same user, a speech is output to confirm the words.

According to the above system, however, in the case of occurrence of mishearing, the distances between the attribute values may be evaluated improperly in some cases. Therefore, there has been a probability that the interaction proceeds without eliminating an inconsistency that the system recognizes the user's speech as “B” acoustically similar to “A,” though the user speaks “A.”

Therefore, it is an object of the present invention to provide a system capable of interacting with a user, while more appropriately eliminating an inconsistency between a user's speech and a recognized speech, and software for providing a computer with interactive functions.

### DISCLOSURE OF THE INVENTION

To resolve the above problem, according to one aspect of the present invention, there is provided an interactive system having a first speech section for recognizing a user's speech and a second speech section for outputting a speech, the interactive system comprising: a first processing section for retrieving a linguistic unit related to a first-order input linguistic unit from a second dictionary database and recognizing the same as a first-order output linguistic unit with a requirement that it is possible to retrieve a linguistic unit acoustically similar to a first-order input linguistic unit, which is included in the speech recognized by the first speech section, from a first dictionary database; and a second processing section for generating a first-order query for asking a user's meaning and causing the second speech section to output the query on the basis of a first-order output linguistic unit recognized by the first processing section and for determining whether the user's meaning conforms or not to the first-order input linguistic unit on the basis of a first-order response recognized by the first speech section as a user's response to the first-order query.

If it is possible to retrieve the linguistic unit acoustically similar to the “first-order input linguistic unit” included in the speech recognized by the first speech section from the first dictionary database, some other linguistic unit could have been included in the user's speech, instead of the first-order input linguistic unit. More specifically, in this case, the first speech section could have misheard the first-order input linguistic unit in any way. In view of this, the “first-order output linguistic unit” related to the first-order input linguistic unit is retrieved from the second dictionary database.

Moreover, the “first-order query” corresponding to the first-order output linguistic unit is generated and output. Thereafter, it is determined whether the user's meaning conforms to the first-order input linguistic unit on the basis of the “first-order response” recognized as the user's speech to the first-order query. This enables an interaction between the user and the system while preventing an inconsistency between the user's speech (meaning) and the speech recognized by the system more reliably.

The “linguistic unit” means a sentence composed of characters, words, and a plurality of words, a long sentence composed of short sentences, or the like.

Furthermore, the interactive system according to the present invention is characterized in that: the first processing section recognizes a plurality of first-order output linguistic units; and the second processing section selects one of a plurality of the first-order output linguistic units recognized by the first processing section on the basis of factors representing the degrees of difficulty in recognition of a plurality of the first-order output linguistic units, respectively, and generates the first-order query on the basis of the selected first-order output linguistic unit.

According to the interactive system of the present invention, the first-order output linguistic unit is selected on the basis of the factor representing the degree of difficulty in recognition out of a plurality of the first-order output linguistic units, by which the user can recognize the selected first-order output linguistic unit more easily. Thereby, an appropriate first-order query is generated from the viewpoint of determining whether the user's meaning conforms to the first-order input linguistic unit.

Furthermore, the interactive system according to the present invention is characterized in that the second processing section selects one of a plurality of the first-order output linguistic units recognized by the first processing section, on the basis of one or both of a first factor that represents the degree of difficulty in conceptual recognition or the frequency of occurrence within a given range and a second factor that represents the degree of difficulty in acoustic recognition or a minimum average of acoustic distances from a given number of other linguistic units, regarding each of a plurality of the first-order output linguistic units.

According to the interactive system of the present invention, the user can conceptually or acoustically recognize the selected first-order output linguistic unit more easily. Thereby, an appropriate first-order query is generated from the viewpoint of determining whether the user's meaning conforms to the first-order input linguistic unit.

Furthermore, the interactive system according to the present invention is characterized in that the second processing section selects one of a plurality of the first-order output linguistic units on the basis of the acoustic distance between the first-order input linguistic unit and each of a plurality of the first-order output linguistic units recognized by the first processing section.

According to the interactive system of the present invention, the first-order output linguistic unit is selected out of a plurality of the first-order output linguistic units on the basis of the acoustic distances from the first-order input linguistic units, by which the user can acoustically distinguish the selected first-order output linguistic unit from the first-order input linguistic unit more easily.

Furthermore, the interactive system according to the present invention is characterized in that the first processing section recognizes, as the first-order output linguistic unit, a part or all of: a first type linguistic unit including a different part between the first-order input linguistic unit and a linguistic unit acoustically similar thereto; a second type linguistic unit representing a different reading from the original reading in the different part; a third type linguistic unit representing a reading of a linguistic unit corresponding to the different part in another language system; a fourth type linguistic unit representing one phoneme included in the different part; and a fifth type linguistic unit conceptually similar to the first-order input linguistic unit.

Still further, the interactive system according to the present invention is characterized in that the first processing section recognizes a plurality of linguistic units among the kth type linguistic unit group (k=1 to 5), as the first-order output linguistic units.

According to the interactive system of the present invention, it is possible to increase the number of choices of the first-order output linguistic units, which constitute the base of generating the first-order query. Therefore, the most suitable first-order query can be generated from the viewpoint of determining whether the user's meaning conforms to the first-order input linguistic unit.

Furthermore, the interactive system according to the present invention is characterized in that, if the second processing section determines that the user's meaning does not conform to an ith-order input linguistic unit (i=1, 2, --), then: the first processing section retrieves a linguistic unit acoustically similar to the ith-order input linguistic unit from the first dictionary database and recognizes the same as an (i+1)th-order input linguistic unit, and retrieves a linguistic unit related to the (i+1)th-order input linguistic unit from the second dictionary database and recognizes the same as an (i+1)th-order output linguistic unit; and the second processing section generates an (i+1)th-order query for asking the user's meaning and causes the second speech section to output the same on the basis of the (i+1)th-order output linguistic unit recognized by the first processing section, and determines whether the user's meaning conforms or not to the (i+1)th-order input linguistic unit on the basis of an (i+1)th-order response recognized by the first speech section as a user's response to the (i+1)th-order query.

According to the interactive system of the present invention, the “(i+1)th-order output linguistic unit” related to the (i+1)th-order input linguistic unit is retrieved from the second dictionary database in view of the fact that the “(i+1)th-order input linguistic unit” as a linguistic unit acoustically similar to the ith-order input linguistic unit included in the speech recognized by the first speech section could have been included in the user's speech. Moreover, the “(i+1)th-order query” is generated and output based on the (i+1)th-order output linguistic unit. Thereafter, it is determined whether the user's meaning conforms to the (i+1)th-order input linguistic unit on the basis of the “(i+1)th-order response” recognized as a user's speech to the (i+1)th-order query. In this way, a plurality of queries for asking the user's meaning are output to the user. This enables an interaction between the user and the system while preventing the inconsistency between the user's speech (meaning) and the speech recognized by the system more reliably.

Furthermore, the interactive system according to the present invention is characterized in that: the first processing section recognizes a plurality of (i+1)th-order output linguistic units; and the second processing section selects one of a plurality of the (i+1)th-order output linguistic units on the basis of factors representing the degrees of difficulty in recognition of a plurality of the (i+1)th-order output linguistic units recognized by the first processing section, respectively, and generates an (i+1)th-order query on the basis of the selected (i+1)th-order output linguistic unit.

According to the interactive system of the present invention, the (i+1)th-order output linguistic unit is selected on the basis of the factors representing the degrees of difficulty in recognition out of the plurality of (i+1)th-order output linguistic units, by which the user can recognize the selected (i+1)th-order output linguistic unit more easily. This enables the generation of an appropriate (i+1)th-order query from the viewpoint of determining whether the user's meaning conforms to the (i+1)th-order input linguistic unit.

Furthermore, the interactive system according to the present invention is characterized in that the second processing section selects one of a plurality of the (i+1)th-order output linguistic units, on the basis of one or both of a first factor that represents the degree of difficulty in conceptual recognition or the frequency of occurrence within a given range and a second factor that represents the degree of difficulty in acoustic recognition or a minimum average of acoustic distances from a given number of other linguistic units, regarding each of the (i+1)th-order output linguistic units.

According to the interactive system of the present invention, the user can conceptually or acoustically recognize the selected (i+1)th-order output linguistic unit more easily. This enables the generation of an appropriate (i+1)th-order query from the viewpoint of determining whether the user's meaning conforms to the (i+1)th-order input linguistic unit.

Still further, the interactive system according to the present invention is characterized in that the second processing section selects one of a plurality of the (i+1)th-order output linguistic units recognized by the first processing section, on the basis of one or both of a first factor that represents the degree of difficulty in conceptual recognition or the frequency of occurrence within a given range and a second factor that represents the degree of difficulty in acoustic recognition or a minimum average of acoustic distances from a given number of other linguistic units, regarding each of the plurality of (i+1)th-order output linguistic units.

According to the interactive system of the present invention, the (i+1)th-order output linguistic unit can be selected out of a plurality of the (i+1)th-order output linguistic units on the basis of the acoustic distance from the ith-order input linguistic unit. Therefore, the selected (i+1)th-order output linguistic unit can be acoustically distinguished from the ith-order input linguistic unit more easily. Moreover, the (i+1)th-order output linguistic unit can be selected out of a plurality of the (i+1)th-order output linguistic units on the basis of the acoustic distance from the (i+1)th-order input linguistic unit. Therefore, the selected (i+1)th-order output linguistic unit can be acoustically distinguished from the (i+1)th-order input linguistic unit more easily.

Furthermore, the interactive system according to the present invention is characterized in that the first processing section recognizes, as a second-order output linguistic unit, a part or all of: a first type linguistic unit including a different part between the (i+1)th-order input linguistic unit and a linguistic unit acoustically similar thereto; a second type linguistic unit representing a different reading from the original reading in the different part; a third type linguistic unit representing a reading of a linguistic unit corresponding to the different part in another language system; a fourth type linguistic unit representing one phoneme included in the different part; and a fifth type linguistic unit conceptually similar to the (i+1)th-order input linguistic unit.

Still further, the interactive system according to the present invention is characterized in that the first processing section recognizes a plurality of linguistic units among the kth type linguistic unit group (k=1 to 5), as the (i+1)th-order output linguistic units.

According to the interactive system of the present invention, it is possible to increase the number of choices of the (i+1)th-order output linguistic units, which constitute the base of generating the (i+1)th-order query. Therefore, the most suitable (i+1)th-order query can be generated from the viewpoint of determining whether the user's speech conforms to the (i+1)th-order input linguistic unit.

Furthermore, the interactive system according to the present invention is characterized in that, if the second processing section determines that the user's meaning does not conform to a jth-order input linguistic unit (j≧2), the second processing section generates a query that prompts the user to speak again and causes the second speech section to output the query.

According to the interactive system of the present invention, in the case where the user's meaning cannot be confirmed by the sequentially output queries, it is possible to confirm the meaning again.

To resolve the aforementioned problem, according to another aspect of the present invention, there is provided an interactive software to be stored in a computer storage facility having a first speech function of recognizing a user's speech and a second speech function of outputting a speech, wherein the interactive software provides the computer with: a first processing function of retrieving a linguistic unit related to a first-order input linguistic unit from a second dictionary database and recognizing the same as a first-order output linguistic unit, with a requirement that it is possible to retrieve a linguistic unit acoustically similar to the first-order input linguistic unit, which is included in the speech recognized by the first speech function, from a first dictionary database; and a second processing function of generating a first-order query for asking a user's meaning and outputting the same by using the second speech function on the basis of the first-order output linguistic unit recognized by the first processing function and of determining whether the user's meaning conforms or not to the first-order input linguistic unit on the basis of a first-order response recognized by the first speech section as a user's response to the first-order query.

According to the interactive software of the present invention, the computer is provided with the functions of interacting with the user while preventing the inconsistency between the user's speech (or meaning) and the speech recognized by the system more reliably.

Furthermore, the interactive software of the present invention is characterized in that, if the second processing function determines that the user's meaning does not conform to an ith-order input linguistic unit (i=1, 2, --), the interactive software provides the computer with: a function as the first processing function of retrieving a linguistic unit acoustically similar to the ith-order input linguistic unit from the first dictionary database and recognizing the same as an (i+1)th-order input linguistic unit and of retrieving a linguistic unit related to the (i+1)th-order input linguistic unit from the second dictionary database and recognizing the same as an (i+1)th-order output linguistic unit; and a function as the second processing function of generating an (i+1)th-order query for asking the user's meaning and causing the second speech function to output the same on the basis of the (i+1)th-order output linguistic unit recognized by the first processing function and of determining whether the user's meaning conforms or not to the (i+1)th-order input linguistic unit on the basis of an (i+1)th-order response recognized by the first speech function as a user's response to the (i+1)th-order query.

According to the interactive software of the present invention, the computer is provided with the function of generating a plurality of queries for asking the user's meaning. Therefore, the computer is provided with a function of interacting with the user while understanding the user's meaning more accurately and preventing an inconsistency between the user's speech and the speech recognized by the system more reliably.

### BRIEF DESCRIPTION OF THE DRAWINGS

FIG. 1 is a configuration diagram of an interactive system according to the present invention.

FIG. 2 is a functional diagram of the interactive system and interactive software according to the present invention.

### BEST MODE FOR CARRYING OUT THE INVENTION

Preferred embodiments of an interactive system and interactive software according to the present invention will be described below by using the accompanying drawings.

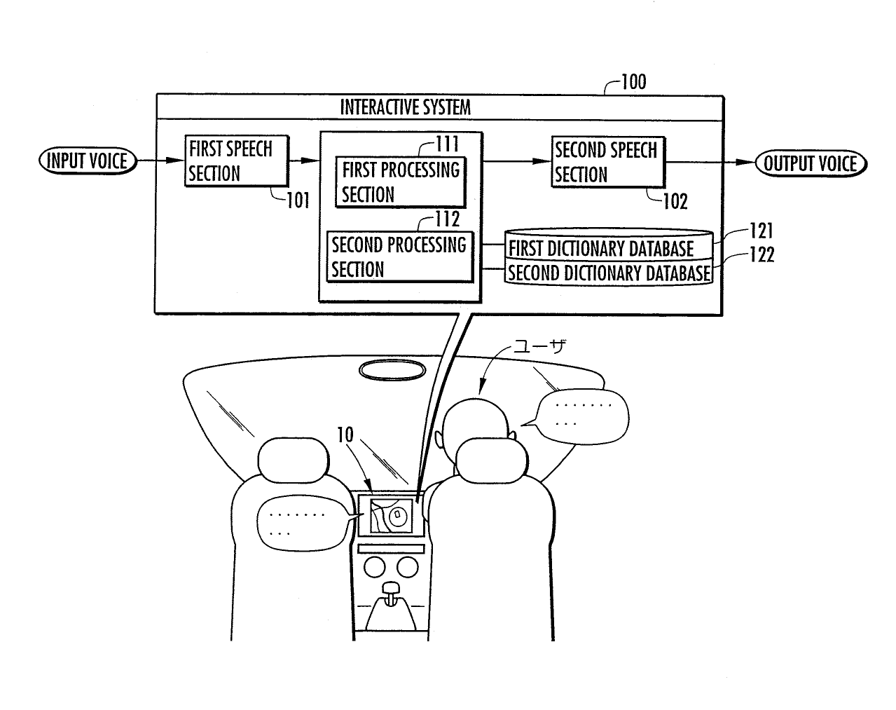

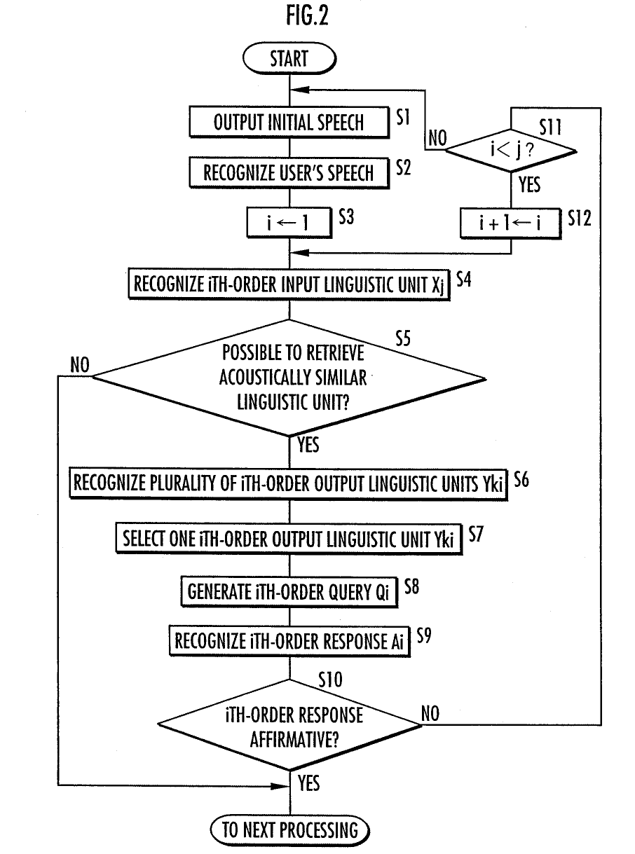

Referring to FIG. 1, there is shown a configuration diagram of the interactive system according to the present invention. Referring to FIG. 2, there is shown a functional diagram of the interactive system and interactive software according to the present invention.

The interactive system (hereinafter, referred to as “system”) 100 is composed of a computer as hardware incorporated into a navigation system (navi-system) 10, which is mounted on a motor vehicle, and “interactive software” of the present invention stored in a memory of the computer.

The interactive system 10 includes a first speech section 101, a second speech section 102, a first processing section 111, a second processing section 112, a first dictionary database 121, and a second dictionary database 122.

The first speech section 101, which is formed of a microphone (not shown) or the like, recognizes a user's speech based on an input voice according to a known technique such as hidden Markov model.

The second speech section 102, which is formed of a speaker (not shown) or the like, outputs a voice (or a speech).

The first processing section 111 retrieves a plurality of types of linguistic units related to a first-order input linguistic unit from the second dictionary database 122 and recognizes them as first-order output linguistic units, with a requirement that it is possible to retrieve linguistic units acoustically similar to a first-order input linguistic unit, which is included in the speech recognized by the first speech section 101, from the first dictionary database 121. Furthermore, the first processing section 111 recognizes a higher-order output linguistic unit, if necessary, as described later.

The second processing section 112 selects one of a plurality of the types of first-order output linguistic units recognized by the first processing section 111 on the basis of the first-order input linguistic unit. Furthermore, the second processing section 112 generates a first-order query for asking a user's meaning and causes the second speech section 102 to output the same on the basis of the selected first-order output linguistic unit. Still further, the second processing section 112 determines whether the user's meaning conforms to the first-order input linguistic unit on the basis of a first-order response recognized by the first speech section 101 as a user's response to the first-order query. Furthermore, the second processing section 112 generates a higher-order query, if necessary, as described later and confirms the user's meaning on the basis of a higher-order response.

The first dictionary database 121 stores a plurality of linguistic units that can be recognized as (i+1)th-order input linguistic units (i=1, 2, --) by the first processing section 111.

The second dictionary database 122 stores a plurality of linguistic units that can be recognized as ith-order output linguistic units by the first processing section 111.

Functions of the system 10 having the above configuration will be described by using FIG. 2.

First, in response to a user's operation of the navi-system 10 for the purpose of setting a destination, the second speech section 102 outputs an initial speech, “Where is your destination?” (FIG. 2: S1). In response to the initial speech, the user speaks a word that mean a destination, and then the first speech section 101 recognizes this speech (FIG. 2: S2). At this moment, index i representing the order of the input linguistic unit, output linguistic unit, query, and response is set to 1 (FIG. 2: S3).

Moreover, the first processing section 111 converts the speech recognized by the first speech section 101 to a linguistic unit string and then extracts a linguistic unit classified as a “regional name,” “building name,” or the like in the first dictionary database 121 from the linguistic unit and recognizes the same as an ith-order input linguistic unit xᵢ (FIG. 2: S4). The classification of the linguistic unit extracted from the linguistic unit string is based on a domain in which a navi-unit 1 presents a guide route up to the destination to the user.

Furthermore, the first processing section 111 determines whether a linguistic unit acoustically similar to the ith-order input linguistic unit xᵢ can be retrieved from the first dictionary database 121, in other words, whether the acoustically similar word is stored in the first dictionary database 121 (FIG. 2: S5). The linguistic units xᵢ and xⱼ acoustically similar to each other means that the acoustic distance pd(xᵢ, xⱼ) defined by the following equation (1) is less than a threshold value:
pd(xᵢ,xᵢ)=ed(xᵢ,xⱼ)/ln[min(|xᵢ|,|xⱼ|)+1] (1)

In the equation (1), |x| is the number of phonemes (or phonetic units) included in the linguistic unit x. The term “phoneme” means the smallest unit of sound, which is used in a language, defined from the viewpoint of discrimination function.

Furthermore, ed(xᵢ, xⱼ) is an editing distance between the linguistic units xᵢ and xⱼ, and it is obtained by DP matching, under the condition that the cost is set to 1 if the number of moras (the term “mora” means the smallest unit of a Japanese pronunciation) or phonemes varies and that the cost is set to 2 if the number of moras or phonemes does not vary, at the time of insertion, deletion, or replacement of phonemes for converting a phoneme string of the linguistic unit xᵢ to a phoneme string of the linguistic unit xⱼ.

The first processing section 111 retrieves a plurality of types of ith-order output linguistic units yₖᵢ=yₖ(xᵢ)(k=1 to 5) related to the ith-order input linguistic unit xi from the second dictionary database 122 (FIG. 2: S6) if it determines that a linguistic unit acoustically similar to the ith-order input linguistic unit xi is registered in the first dictionary database 121 (FIG. 2: S5—YES).

More specifically, the first processing section 111 retrieves a linguistic unit, which includes a different part δ₁=δ(xᵢ, zᵢ) from the acoustically similar linguistic unit zᵢ in the ith-order input linguistic unit xᵢ, out of the second dictionary database 122 and recognizes the same as a first type ith-order output linguistic unit y₁ᵢ=y₁(xᵢ). For example, if the ith-order input linguistic unit xᵢ is a word indicating a place name “Boston” and the acoustically similar linguistic unit zᵢ is a word indicating a place name “Austin,” “b” of the initial letter of the ith-order input linguistic unit xᵢ is extracted as the different part δᵢ. In addition, “bravo” is retrieved as a linguistic unit including the different part δᵢ.

Moreover, the first processing section 111 retrieves different reading p₂ᵢ=p₂(δᵢ) from the reading (original reading) p₁ᵢ=p₁(bᵢ) of the different part δᵢ out of the second dictionary database 122 and recognizes the same as a second type ith-order output linguistic unit y₂ᵢ=y₂(xᵢ). For example, in Japanese, there are different readings, namely, the Chinese reading and the Japanese reading in most kanji. Therefore, if the original reading of kanji “ [symbol] which is the different part δᵢ, is “gin” in the Chinese reading, the Japanese reading of the kanji “shirogane” is recognized as the second type ith-order output linguistic unit y₂ᵢ.

Furthermore, the first processing section 111 retrieves the reading p(f) of a linguistic unit f=f(δᵢ), which means the different part δᵢ in another linguistic unit, out of the second dictionary database 122 and recognizes the same as a third type ith-order output linguistic unit y₃ᵢ=y₃(xᵢ). For example, if a kanji [symbol] in Japanese is the different part δᵢ, the reading “sirubaa” of the English word “silver” that means the aforementioned kanji is recognized as the third type ith-order output linguistic unit y₃₁.

Moreover, if the reading p(δᵢ) of the different part δᵢ is composed of a plurality of moras (or phonemes), the first processing section 111 retrieves a phonemic character that represents one mora such as the first mora or a sentence that explains the mora among a plurality of the moras from the second dictionary database 122 and recognizes the same as a fourth type ith-order output linguistic unit y₄ᵢ=y₄(xᵢ). For example, if a kanji [symbol] in Japanese is the different part δᵢ, the first mora character “ni” is recognized as the fourth type ith-order output linguistic unit y₄ᵢ in the reading p(δᵢ) “nishi.” In addition, there are categories: resonant sound, p-sound (consonant: p), and dull sound (consonant: g, z, d, b) in Japanese moras. Therefore, the words, “resonant sound,” np-sound,” and “dull sound” that indicate the categories are recognized as the fourth type ith-order output linguistic units y₄ᵢ.

Furthermore, the first processing section 111 retrieves a linguistic unit conceptually related to the ith-order input linguistic unit xᵢ from the second dictionary database 122 and recognizes the same as a fifth type ith-order output linguistic unit y₅ᵢ=y₅(xᵢ). For example, a linguistic unit (a place name) g=g(xᵢ) that represents an area including the destination represented by the ith-order input linguistic unit xᵢ is recognized as the fifth type ith-order output linguistic unit y₅ᵢ.

A plurality of linguistic units can be recognized as a k type ith-order output linguistic unit. For example, if the different part δᵢ is a kanji [symbol] both of a sentence” [symbol] (Silence is gold)” classified as a historical idiom and a name [symbol] classified as a celebrity's name can be recognized as the first type ith-order output linguistic units y₁ᵢ.

On the other hand, if the first processing section 111 determines that the linguistic unit acoustically similar to the ith-order input linguistic unit xᵢ is not registered in the first dictionary database 121 (FIG. 2: S5—NO), the next processing is performed according to an estimation that the ith-order input linguistic unit xᵢ is for use in specifying the user's destination name. Thereby, for example, the second speech section 102 outputs a speech, “Then, I'll show you the route to the destination xᵢ” or the like. In addition, the navi-system 10 performs setting processing for the route to the destination specified by the ith-order input linguistic unit xᵢ.

Subsequently, the second processing section 112 selects one of the first to fifth ith-order output linguistic units yₖᵢ recognized by the first processing section 111 (FIG. 2: S7).

More specifically, the second processing section 112 calculates a first-order index score₁(yₖᵢ) in accordance with the following equation (2) regarding the various ith-order output linguistic units yₖᵢ and then selects the ith-order output linguistic unit yₖᵢ having the maximum ith-order index score₁(yₖi).
score₁(yₖ₁)=W₁·c₁(yₖ₁)+W₂·c₂(yₖ₁)+W₃·pd(x₁, yₖ₁),
scoreᵢ₊₁(yₖᵢ₊₁)=W₁·c₁(yₖᵢ₊₁)+W₂·c₂(yₖᵢ₊₁)+W₃·pd(xᵢ, yₖᵢ₊₁)+

$${score}_{1} ( {y}_{k 1} ) = {W}_{1} \cdot {c}_{1} ( {y}_{k 1} ) + {W}_{2} \cdot {c}_{2} ( {y}_{k 1} ) + {W}_{3} \cdot pd ( {x}_{1} , {y}_{k 1} ) , \\ {score}_{1 + 1} ( {y}_{ki + 1} ) = {W}_{1} \cdot {c}_{1} ( {y}_{ki + 1} ) + {W}_{2} \cdot {c}_{2} ( {y}_{ki + 1} ) + {W}_{3} \cdot pd ( {x}_{1} , {y}_{ki + 1} ) + {W}_{4} \cdot pd ( {y}_{ki} , {y}_{ki + 1} ) \qquad ( 2 )$$

W₄·pd(yₖᵢ,yₖᵢ₊₁) (2)

In the equation (2), W₁ to W₄ are weighting factors. c₁(yₖᵢ) is a first factor that represents the degree of difficulty (familiarity) in conceptual recognition of the kth type ith-order output linguistic unit yₖᵢ. As the first factor, there is used the number of hits from an Internet search engine with the ith-order output linguistic unit yₖᵢ used as a keyword, the frequency of occurrence in mass media such as major newspapers and broadcasting, or the like. In addition, c₂(yₖᵢ) is a second factor that represents the degree of difficulty (a uniqueness in pronunciation or listenability) in acoustic recognition of the kth type ith-order output linguistic unit yₖᵢ. As the second factor, there is used, for example, the minimum average of acoustic distances from a given number of (for example, 10) other linguistic units (homonyms and so on). pd(x, y) is an acoustic distance between the linguistic unit x and y defined by the equation (1).

Subsequently, the second processing section 112 generates the ith-order query Qᵢ=Q(yᵢ) for asking the user's meaning on the basis of the selected ith-order output linguistic unit yₖᵢ and causes the second speech section 102 to output the same (FIG. 2: S8).

For example, the second processing section 112 generates the ith-order query Qᵢ such as “Does the destination name include a character δᵢ included in y₁ᵢ?” in accordance with the selection of the first type ith-order output linguistic unit y₁ᵢ. This ith-order query Qᵢ is for use in confirming with the user indirectly if the recognition of the ith-order input linguistic unit (for example, a place name or building name included in the speech) xᵢ is correct or incorrect through the different part δᵢ.

In addition, it generates the ith-order query Qᵢ such as “Does the destination name include a character read (or pronounced) as p₂ᵢ?” in accordance with the selection of the second type ith-order output linguistic unit y₁ᵢ. This ith-order query Qᵢ is for use in confirming with the user indirectly if the recognition of the ith-order input linguistic unit xᵢ is correct or incorrect through the different reading p₂ᵢ from the original reading p₁ᵢ of the different part δᵢ.

Furthermore, the second processing section 112 generates the ith-order query Qᵢ such as “Does the destination name include a character δᵢ that means p in a foreign language (for example, English for Japanese speakers)?” in accordance with the selection of the third type ith-order output linguistic unit y₁ᵢ. This ith-order query Qᵢ is for use in confirming with the user indirectly if the recognition of the ith-order input linguistic unit xᵢ is correct or incorrect through the reading p(f) of the linguistic unit f=f(δᵢ) that means the different part δᵢ in another linguistic unit.

Still further, the second processing section 112 generates the ith-order query Qᵢ such as “Does the destination name include an nth character pronounced as p(δᵢ)?” in accordance with the selection of the fourth type ith-order output linguistic unit y₁ᵢ. This ith-order query Qᵢ is for use in confirming with the user indirectly if the recognition of the ith-order input linguistic unit xᵢ is correct or incorrect through a character that represents one mora or a sentence that explains the mora in the reading p(δᵢ) of the different part δᵢ.

Furthermore, the second processing section 112 generates the ith-order query Qᵢ such as “Is the destination included in g?” in accordance with the selection of the fifth type ith-order output linguistic unit y₁ᵢ. This ith-order query Qᵢ is for use in confirming with the user indirectly if the recognition of the ith-order input linguistic unit xᵢ is correct or incorrect through the linguistic unit conceptually related to the ith-order input linguistic unit xᵢ.

Moreover, the first speech section 101 recognizes an ith-order response Aᵢ as user's speech to the ith-order query Qᵢ (FIG. 2: S9). In addition, the second processing section 112 determines whether the ith-order response Aᵢ is affirmative like “YES” or negative like “NO” (FIG. 2: S10).

Then, if the second processing section 112 determines that the ith-order response Aᵢ is affirmative (FIG. 2: S10—YES), the next processing is performed in accordance with an estimation that the ith-order input linguistic unit xᵢ is for use in specifying the user's destination name.

On the other hand, if the second processing section 112 determines that the ith-order response Aᵢ is negative (FIG. 2: S10—NO), it is determined whether a condition that the index i is less than a given number j (>2) is satisfied (FIG. 2: S11). If the condition is satisfied (FIG. 2: S11—YES), the index i is incremented by 1 (FIG. 2: S12) and then processing of S4 to S10 is repeated. In this processing, the first processing section 111 retrieves a linguistic unit acoustically similar to the (i−1)th-order input linguistic unit xᵢ₋₁ (i≧2) from the first dictionary database 121 and recognizes the same as the ith-order input linguistic unit xᵢ. The acoustically similar linguistic unit zᵢ₋₁, of the (i−1)th-order input linguistic unit xᵢ₋₁ can also be recognized as the ith-order input linguistic unit xᵢ. Moreover, unless the condition is satisfied (FIG. 2: S11—NO), the interaction with the user is started again from the beginning, in such a way that the second speech section 102 outputs an initial speech anew (FIG. 2: S1).

According to the interactive system 100 (and interactive software) that fulfills the above functions, one is selected out of a plurality of the types of ith-order output linguistic units yₖᵢ on the basis of the first factor c₁ that represents the degree of difficulty in conceptual recognition and the second factor c₂ that represents the degree of difficulty in acoustic recognition, with respect to each of the ith-order output linguistic units yₖᵢ (FIG. 2: S6, S7). In addition, the ith-order query Qᵢ is generated on the basis of the selected ith-order output linguistic unit yₖᵢ (FIG. 2: S8). Thereby, the most suitable ith-order query Qᵢ is generated from the viewpoint of determining whether the user's meaning conforms to the ith-order input linguistic unit xᵢ. If it is determined that there is an inconsistency between the user's meaning and the system recognition, a new query is generated (FIG. 2: S10—NO, S4 to S10). Therefore, it is possible to provide an interaction between the user and the system 100 while reliably preventing the inconsistency between the user's speech (meaning) and the speech recognized by the system 100.

Furthermore, unless the user's meaning conforms to the jth-order input linguistic unit (j≧2), an initial query is generated to prompt the user to speak again (FIG. 2: S11—NO, S1). Thereby, in the case where the user's meaning cannot be confirmed by the sequentially output queries, the meaning can be confirmed again.

A first interaction example between the user and the interactive system 100 will be described below according to the above processing, where U is the user's speech and S is the speech of the interactive system 100.

(First Interaction Example)

S0: Where is your destination?
U₀: Kinkakuji ( [symbol] ; Golden Pavilion).
S1: Does the destination name include a character [symbol] which means silver in English?
U₁: No.
S₂: Well then, does the destination name include a character [symbol] as used in [symbol] (Silence is gold)”?
U₂: Yes.
S3: Then, I'll show you the route to Kinkakuji.

The speech S₀ of the system 100 corresponds to an initial query (FIG. 2: S1).

The speech S1 of the system 100 corresponds to the first-order query Q₁ (FIG. 2: S8). The first-order query Q₁ is generated according to the following facts: “Ginkakuji (Silver Pavilion)” is recognized (incorrectly recognized), instead of “Kinkakuji,” as the first-order input linguistic unit x₁ (FIG. 2: S4); “Kinkakuji” is recognized as the acoustically similar linguistic unit z₁ (FIG. 2: S5); five types of first-order output linguistic units y₁₁ to y₅₁ are recognized as those related to the kanji [symbol] which is a different part δ₁ between two linguistic units x₁ and z₁ (FIG. 2: S6); and the reading of the Japanese word “sirubaa” is selected as one corresponding to the English word “silver” that represents the different part δ₁ as the third type first-order output linguistic unit y₃₁ (FIG. 2: S7).

The speech S₂ of the system 100 corresponds to the second-order query Q2 (FIG. 2: S8). The second-order query Q₂ is generated according to the following facts: the user's speech U₁ recognized as the first-order response A₁ is negative (FIG. 2: S10—NO); “Kinkakuji” is recognized as the second-order input linguistic unit x₂ (FIG. 2: S4); “Ginkakuji” is recognized as the acoustically similar linguistic unit z₂ (FIG. 2: S5); five types of second-order output linguistic units y₁₂ to y₅₂ are recognized as those related to the kanji [symbol] which is a different part δ₂ between two linguistic units x₂ and z₂ (FIG. 2: S6); and the historical idiom [symbol] including the different part δ₂ is selected as the first type second-order output linguistic unit y₁₂ (FIG. 2: S7).

According to the affirmative user's speech U₂ recognized as the second-order response A₂ (FIG. 2: S10—YES), the system 100 outputs the speech U₄ based on the determination that the user's destination is Kinkakuji.

This prevents the situation where the interaction proceeds between the user and the system 100 while such an inconsistency occurs that the destination recognized by the system 100 is “Ginkakuji,” though the user's destination is “Kinkakuji.” In other words, the system 100 can correctly recognize that the user's destination is Kinkakuji. Therefore, the navi-system 10 can perform appropriate processing such as setting of a guide route to Kinkakuji in view of the user's meaning on the basis of the recognition of the system 100.

Furthermore, a second interaction example between the user and the system 100 will be described below according to the above processing.

(Second Interaction Example)

S₀: Can you tell me the departure city?
U₀: From Austin.
S₁: Is the first letter of the city “b” in “bravo”?
U₁: no.
S₂: Then is the first letter of the city “a” in “alpha”?
U₂: Yes.

The speech S₀ of the system 100 corresponds to the initial query (FIG. 2: S8).

The speech S1 of the system 100 corresponds to the first-order query Q₁ (FIG. 2: S1). The first-order query Q₁ is generated according to the following facts: “Boston” is recognized (incorrectly recognized), instead of “Austin,” as the first-order input linguistic unit xᵢ (FIG. 2: S4); “Austin” is recognized as the acoustically similar linguistic unit z₁ (FIG. 2: S5); five types of first-order output linguistic units y₁₁ to y₅₁ are recognized as those related to the English letter “b,” which is a different part δ₁ between two linguistic units x₁ and z₁ (FIG. 2: S6); and the English word “bravo” is selected as one representing the different part δ₁ as the first type first-order output linguistic unit y₁₁ (FIG. 2: S7).

The speech S₂ of the system 100 corresponds to the second-order query Q₂ (FIG. 2: S8). The second-order query Qis generated according to the following facts: the user's speech U₁ recognized as the first-order response A₁ is negative (FIG. 2: S10—NO); “Austin” is recognized as the second-order input linguistic unit x₂ (FIG. 2: S4); “Boston” is recognized as the acoustically similar linguistic unit z₂ (FIG. 2: S5); five types of second-order output linguistic units y₁₂ to y₅₂ are recognized as those related to the English letter “a,” which is a different part δ₂ between two linguistic units x₂ and z₂ (FIG. 2: S6); and the English word “alpha” including the different part δ₂ is selected as the first type second-order output linguistic unit y₁₂ (FIG. 2: S7).

According to the affirmative user's speech U₂ recognized as the second-order response A₂ (FIG. 2: S10—YES), the system 100 outputs the speech based on the determination that the user's destination is Austin.

This prevents the situation where the interaction proceeds between the user and the system 100 while such an inconsistency occurs that the destination recognized by the system 100 is “Boston,” though the user's destination is “Austin.” In other words, the system 100 can correctly recognize that the user's destination is Austin. Therefore, the navi-system 10 can perform appropriate processing such as setting of a guide route to Austin in view of the user's meaning on the basis of the recognition of the system 100.

1. An interactive system having a first speech section for recognizing a user's speech and a second speech section for outputting a speech, the interactive system comprising:
a first processing section for retrieving a linguistic unit related to a first-order input linguistic unit from a second dictionary database and recognizing the same as a first-order output linguistic unit with a requirement that it is possible to retrieve a linguistic unit acoustically similar to a first-order input linguistic unit, which is included in the speech recognized by the first speech section, from a first dictionary database; and
a second processing section for generating a first-order query for asking a user's meaning and causing the second speech section to output the query on the basis of a first-order output linguistic unit recognized by the first processing section and for determining whether the user's meaning conforms or not to the first-order input linguistic unit on the basis of a first-order response recognized by the first speech section as a user's response to the first-order query.

2. The interactive system according to claim 1, wherein:
the first processing section recognizes a plurality of first-order output linguistic units; and
the second processing section selects one of a plurality of the first-order output linguistic units recognized by the first processing section on the basis of factors representing the degrees of difficulty in recognition of a plurality of the first-order output linguistic units, respectively, and generates the first-order query on the basis of the selected first-order output linguistic unit.

3. The interactive system according to claim 2, wherein the second processing section selects one of a plurality of the first-order output linguistic units recognized by the first processing section, on the basis of one or both of a first factor that represents the degree of difficulty in conceptual recognition or the frequency of occurrence within a given range and a second factor that represents the degree of difficulty in acoustic recognition or a minimum average of acoustic distances from a given number of other linguistic units, regarding each of a plurality of the first-order output linguistic units.

4. The interactive system according to claim 2, wherein the second processing section selects one of a plurality of the first-order output linguistic units on the basis of the acoustic distance between the first-order input linguistic unit and each of a plurality of the first-order output linguistic units recognized by the first processing section.

5. The interactive system according to claim 2, wherein the first processing section recognizes, as the first-order output linguistic unit, a part or all of:
a first type linguistic unit including a different part between the first-order input linguistic unit and a linguistic unit acoustically similar thereto;
a second type linguistic unit representing a different reading from the original reading in the different part;
a third type linguistic unit representing a reading of a linguistic unit corresponding to the different part in another language system;
a fourth type linguistic unit representing one phoneme included in the different part; and
a fifth type linguistic unit conceptually similar to the first-order input linguistic unit.

6. The interactive system according to claim 5, wherein the first processing section recognizes a plurality of linguistic units among the kth type linguistic unit group (k=1 to 5), as the first-order output linguistic units.

7. The interactive system according to claim 1, wherein, if the second processing section determines that the user's meaning does not conform to an ith-order input linguistic unit (i=1, 2, --), then:
the first processing section retrieves a linguistic unit acoustically similar to the ith-order input linguistic unit from the first dictionary database and recognizes the same as an (i+1)th-order input linguistic unit, and then retrieves a linguistic unit related to the (i+1)th-order input linguistic unit from the second dictionary database and recognizes the same as an (i+1)th-order output linguistic unit; and
the second processing section generates an (i+1)th-order query for asking the user's meaning and causes the second speech section to output the same on the basis of the (i+1 )th-order output linguistic unit recognized by the first processing section, and then determines whether the user's meaning conforms or not to the (i+1)th-order input linguistic unit on the basis of an (i+1)th-order response recognized by the first speech section as a user's response to the (i+1)th-order query.

8. The interactive system according to claim 7, wherein:
the first processing section recognizes a plurality of (i+1)th-order output linguistic units; and
the second processing section selects one of a plurality of the (i+1)th-order output linguistic units on the basis of factors representing the degrees of difficulty in recognition of a plurality of the (i+1)th-order output linguistic units recognized by the first processing section, respectively, and generates an (i+1)th-order query on the basis of the selected (i+1)th-order output linguistic unit.

9. The interactive system according to claim 8, wherein the second processing section selects one of a plurality of the (i+1)th-order output linguistic units recognized by the first processing unit, on the basis of one or both of a first factor that represents the degree of difficulty in conceptual recognition or the frequency of occurrence within a given range and a second factor that represents the degree of difficulty in acoustic recognition or a minimum average of acoustic distances from a given number of other linguistic units, regarding each of a plurality of the (i+1)th-order output linguistic units.

10. The interactive system according to claim 7, wherein the second processing section selects one of a plurality of the (i+1)th-order output linguistic units recognized by the first processing section, on the basis of one or both of an acoustic distance between the ith-order input linguistic unit and each of a plurality of the (i+1)th-order output linguistic units and an acoustic distance between the (i+1)th-order input linguistic unit and a plurality of the (i+1)th-order output linguistic units.

11. The interactive system according to claim 8, wherein the first processing section recognizes, as a second-order output linguistic unit, a part or all of:
a first type linguistic unit including a different part between the (i+1)th-order input linguistic unit and a linguistic unit acoustically similar thereto;
a second type linguistic unit representing a different reading from the original reading in the different part;
a third type linguistic unit representing a reading of a linguistic unit corresponding to the different part in another language system;
a fourth type linguistic unit representing one phoneme included in the different part; and
a fifth type linguistic unit conceptually similar to the (i+1)th-order input linguistic unit.

12. The interactive system according to claim 9, wherein the first processing section recognizes a plurality of linguistic units among the kth type linguistic unit group (k=1 to 5), as the (i+1)th-order output linguistic units.

13. The interactive system according to claim 7, wherein, if the second processing section determines that the user's meaning does not conform to a jth-order input linguistic unit (j≧2), the second processing section generates a query that prompts the user to speak again and causes the second speech section to output the query.

14. An interactive software to be stored in a computer storage facility having a first speech function of recognizing a user's speech and a second speech function of outputting a speech, wherein the interactive software provides the computer with:
a first processing function of retrieving a linguistic unit related to a first-order input linguistic unit from a second dictionary database and recognizing the same as a first-order output linguistic unit, with a requirement that it is possible to retrieve a linguistic unit acoustically similar to the first-order input linguistic unit, which is included in the speech recognized by the first speech function, from a first dictionary database; and
a second processing function of generating a first-order query for asking a user's meaning and outputting the same by using the second speech function on the basis of the first-order output linguistic unit recognized by the first processing function and of determining whether the user's meaning conforms or not to the first-order input linguistic unit on the basis of a first-order response recognized by the first speech function as a user's response to the first-order query.

15. The interactive software according to claim 14, wherein, if the second processing function determines that the user's meaning does not conform to an ith-order input linguistic unit (i=1, 2, --), the interactive software provides the computer with:
a function as the first processing function of retrieving a linguistic unit acoustically similar to the ith-order input linguistic unit from the first dictionary database and recognizing the same as an (i+1)th-order input linguistic unit and of retrieving a linguistic unit related to the (i+1)th-order input linguistic unit from the second dictionary database and recognizing the same as an (i+1)th-order output linguistic unit; and
a function as the second processing function of generating an (i+1)th-order query for asking the user's meaning and causing the second speech function to output the same on the basis of the (i+1)th-order output linguistic unit recognized by the first processing function and of determining whether the user's meaning conforms or not to the (i+1)th-order input linguistic unit on the basis of an (i+1)th-order response recognized by the first speech function as a user's response to the (i+1)th-order query.
